(19) United States
(12) Patent Application Publication
(10) Pub. No.: US 2012/0047313 A1
(43) Pub. Date: Feb. 23, 2012

(54) HIERARCHICAL MEMORY MANAGEMENT IN VIRTUALIZED SYSTEMS FOR NON-VOLATILE MEMORY MODELS

(75) Inventors: Suyash Sinha, Kirkland, WA (US); Ajith Jayamohan, Redmond, WA (US)

(73) Assignee: Microsoft Corporation, Redmond, WA (US)

(21) Appl. No.: 12/859,298

(22) Filed: Aug. 19, 2010

(51) Int. Cl. G06F 12/02; G06F 12/00

(52) U.S. Cl. 711/6; 711/170; 711/103; 711/E12.008; 711/E12.001; 711/E12.058

(57) ABSTRACT

A computing apparatus is described herein that includes one or more physical processors and memory, wherein the memory comprises volatile memory and non-volatile memory, and wherein contents of the non-volatile memory are made accessible to the processors directly, without going through the paging hierarchy, in a time and space multiplexed manner. The computing apparatus further includes a plurality of virtual machines executing on one or more processors, wherein the plurality of virtual machines are configured to access both the volatile memory and the non-volatile memory. A manager component manages allocation of the volatile memory and the non-volatile memory across the plurality of virtual machines during execution of the plurality of virtual machines on the processor, thereby giving the virtual machines an illusion of a larger volatile memory (DRAM) space than is actually available.

### BACKGROUND

Currently, commercial cloud computing services are equipped to provide businesses with computation and data storage services, thereby allowing businesses to replace or supplement privately owned information technology (IT) assets, alleviating the burden of managing and maintaining such privately owned IT assets. While feasibility of cloud computing has grown over the last several years, there exists some technological hurdles to overcome before cloud computing becomes adopted in a widespread manner.

One problem that is desirably addressed pertains to the sharing of computing resources by multiple customers. Cloud computing platforms routinely employ virtualization to encapsulate workloads in virtual machines, which are then consolidated on cloud computing servers. Thus, a particular cloud computing server may have multiple virtual machines executing thereon that correspond to multiple different customers. Ideally, for any customer utilizing the server, the use of resources on the server by other virtual machines corresponding to other customers is transparent. Currently, cloud computing providers charge fees to customers based upon usage or reservation of resources such as, but not limited to, CPU hours, storage capacity, and network bandwidth. Service level agreements between the customers and cloud computing providers are typically based upon resource availability, such as guarantees in terms of system uptime, I/O requests, etc. Accordingly, a customer can enter into an agreement with a cloud computing services provider, wherein such agreement specifies an amount of resources that will be reserved or made available to the customer, as well as guarantees in terms of system uptime, etc.

If a customer is not utilizing all available resources of a server, however, it is in the interests of the cloud computing services provider to cause the customer to share computing resources with other customers. This can be undertaken through virtualization, such that workloads of a customer can be encapsulated in a virtual machine, and many virtual machines can be consolidated on a server. Virtualization can be useful in connection with the co-hosting of independent workloads by providing fault isolation, thereby preventing failures in an application corresponding to one customer from propagating to another application that corresponds to another customer.

The number of virtual machines running a customer workload on a single physical hardware configuration can be referred to herein as a consolidation ratio. In terms of seamless resource allocation and sharing facilitated by virtualization, system memory is one of the top resources that holds back substantial increase in consolidation ratios.

Typically, advanced virtualization solutions provide increased consolidations ratios and support memory resource utilization models that dynamically assign and remove memory from virtual machines based on their need. These increased consolidation ratios are achieved through techniques such as dynamic memory insertion/removal, dynamic memory page sharing of identical pages and over-committing memory to virtual machines, wherein the memory is made available on read/write access. Conventionally, the dynamic memory over-commit model uses the disk to page out memory that is not recently used and makes the freed page available for other virtual machines. This model, however, is not optimized with respect to evolving computer hardware architectures.

### SUMMARY

The following is a brief summary of subject matter that is described in greater detail herein. This summary is not intended to be limiting as to the scope of the claims.

Described herein are various technologies pertaining to managing data storage resources in an over-committed virtualized system. The virtualized system may be executing on a computing apparatus that comprises a hierarchical memory/data storage structure. A first tier in the hierarchy is conventional volatile memory, such as RAM, DRAM, SRAM, or other suitable types of volatile memory. A second tier in the hierarchy is non-volatile memory, such as Phase Change Memory, Flash Memory, ROM, PROM, EPROM, EEPROM, FeRAM, MRAM, PRAM, CBRAM, SONOS, Racetrack Memory, NRAM, amongst others. This non-volatile memory can be accessed directly by a hypervisor, and is thus not burdened by latencies associated with paging into and out of main memory from disk. A third tier in the hierarchy is disk, which can be used to page in and page out data to and from main memory. Such a disk typically has a disk volume file system stack executing thereon, which causes accesses to the disk to be slower than memory accesses to the non-volatile memory and the volatile memory.

In accordance with an aspect described in greater detail herein, each virtual machine executing in the virtualized system can be provided with virtual memory in a virtual address space. A portion of this virtual memory can be backed by the volatile memory, a portion of this virtual memory can be backed by the non-volatile memory, and yet another portion of this virtual memory can be backed by the disk. Thus, any given virtual machine will have virtual memory corresponding thereto, and different portions of the physical memory can be dynamically allocated to back the virtual memory for the virtual machine. The usage of volatile memory, non-volatile memory, and disk in the virtualized system can be monitored across several virtual machines, and these physical resources can be dynamically allocated to improve consolidation ratios and decrease latencies that occur in memory over-committed virtualized systems.

In accordance with one exemplary embodiment, each virtual machine can be assigned a guest physical address space, which is the physical address as viewed by a guest operating system executing in a virtual machine. The guest physical address space comprises a plurality of pages, wherein some of the pages can be mapped to system physical addresses (physical address of the volatile memory), some of the pages can be mapped to non-volatile memory, and some of the pages can be mapped to disk. One or more intercepts can be installed on each page in the guest physical address space that is not mapped to a system physical address, wherein the intercepts are employed to indicate that the virtual machine has accessed such page. Information pertaining to a type of access requested by the virtual machine and context corresponding to such access can be retained for future analysis. The accessed page may then be mapped to a system physical address, and an intercept can be installed on the system physical address to obtain data pertaining to how such page is accessed by the virtual machine (e.g., read or write access). Depending on frequency and nature of such accesses, a determination of where the page is desirably retained (e.g., volatile memory, non-volatile memory, or disk) when the virtualized system is in a memory over-committed state can be ascertained.

Other aspects will be appreciated upon reading and understanding the attached figures and description.

### BRIEF DESCRIPTION OF THE DRAWINGS

FIG. 1 is a functional block diagram of an exemplary system that facilitates managing memory resources in a virtualized system.

FIG. 2 is a functional block diagram of an exemplary system that facilitates allocation of a memory aperture to a virtual machine.

FIG. 3 is a functional block diagram of an exemplary system that facilitates installing intercepts on pages in virtual memory and/or physical memory.

FIG. 4 is a functional block diagram of an exemplary system that facilitates managing allocation of resources to virtual machines based at least in part upon monitored intercepts.

FIG. 5 is a functional block diagram of an exemplary system that facilitates managing memory resources in an over-committed virtualized system based at least in part upon intercepts corresponding to a system physical address.

FIG. 6 is a functional block diagram of an exemplary system that facilitates managing memory resources in an over-committed virtualized system.

FIG. 7 is an exemplary depiction of a hierarchical memory arrangement where contents of non-volatile memory are accessible by way of a direct hash.

FIG. 8 is a flow diagram illustrating an exemplary methodology for managing allocation of volatile memory, non-volatile memory, and disk amongst multiple virtual machines executing in a virtualized system.

FIG. 9 is a flow diagram illustrating an exemplary methodology for managing memory resources in an over-committed virtualized system.

FIG. 10 is an exemplary computing system.

### DETAILED DESCRIPTION

Various technologies pertaining to managing memory resources in an over-committed virtualized system will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

A high level overview of an exemplary virtualized system is provided herein. It is to be understood that this overview is not intended to be an exhaustive overview, and that other terminology may be utilized to describe virtualized systems. Generally, a virtualized system comprises one or more virtual machines that access virtual resources that are supported by underlying hardware. The layers of abstraction (virtual memory, virtual processor, virtual devices, etc.) allow for multiple virtual machines to execute in a virtualized system in a consolidated manner.

As will be understood by one skilled in the art, a virtual machine is a self-contained execution environment that behaves as if it were an independent computer. Generally, a virtualized system that allows for multiple virtual machines executing thereon includes a hypervisor, which is a thin layer of software (which can also be referred to as a virtual machine monitor (VMM)) that controls the physical hardware and resides beneath operating systems executing on one or more virtual machines. The hypervisor is configured to provide isolated execution environments (virtual machines), and each virtual machine has a set of resources assigned thereto, such as CPU (virtual processor), memory (virtual memory), and devices (virtual devices). Virtualized systems further include what can be referred to as a “parent partition”, a “root partition”, “Domain0/Dom0”, which can collectively be referred to as a “parent partition”. The parent partition includes a virtualization software stack (VSS). In some implementations, the hypervisor may be a thin layer of software, and at least some of the system virtualization, resource assignment, and management are undertaken by the VSS. In other implementations, however, the hypervisor may be configured to perform all or a substantial portion of the system virtualization, resource assignment, and management. In an example, the VSS can be or include a set of software drivers and services that provide virtualization management and services to higher layers of operating systems. For example, the VSS can provide Application Programming Interfaces (APIs) that are used to create, manage, and delete virtual machines, and uses the hypervisor to create partitions or containers to host virtual machines. Thus, the parent partition manages creation of virtual machines and operates in conjunction with the hypervisor to create virtualized environments.

A virtualized system also includes one or more child partitions, which can include resources for a virtual machine. The child partition is created by the hypervisor and the parent partition acting in conjunction, and can be considered as a repository of resources assigned to the virtual machine. A guest operating system can execute within the child partition.

A virtualized system can also include various memory address spaces—a system physical address space, a guest physical address space, and a guest virtual address space. A system physical address (SPA) in the system physical address space refers to the real physical memory on the machine. Generally, a SPA is a continuous fixed size (e.g., 4 KB) portion of memory. Typically, there is a single system physical address space layout per physical machine. A guest physical address (GPA) in the guest physical address space refers to a physical address in the memory as viewed by a guest operating system running in a virtual machine. A GPA typically is of a fixed size of memory, and there is generally a single GPA space layout per virtual machine. This is an abstraction layer that allows the hypervisor to manage memory allocated to the virtual machine. A guest virtual address (GVA) in the GVA space refers to the virtual memory as viewed by the guest operating system executing in the virtual machine or processes running in the virtual machine. A GVA is mapped to a GPA through utilization of guest page tables, and the GPA is a translation layer to an SPA in the physical machine.

A memory aperture (MA) is a range of SPA pages that the VSS executing in the parent partition can allocate on behalf of the child partition. That is, the VSS can assign the MA to the GPA space of the child partition. Generally, MAs are over-committed, meaning that a portion of an MA is available in SPA and the remainder is mapped to some other storage. A memory aperture page (MAP) is a page belonging to a certain MA region. The page can be resident on the SPA or may be moved to a backing store when managing memory. The backing store, as will be described herein, may be non-volatile memory or disk.

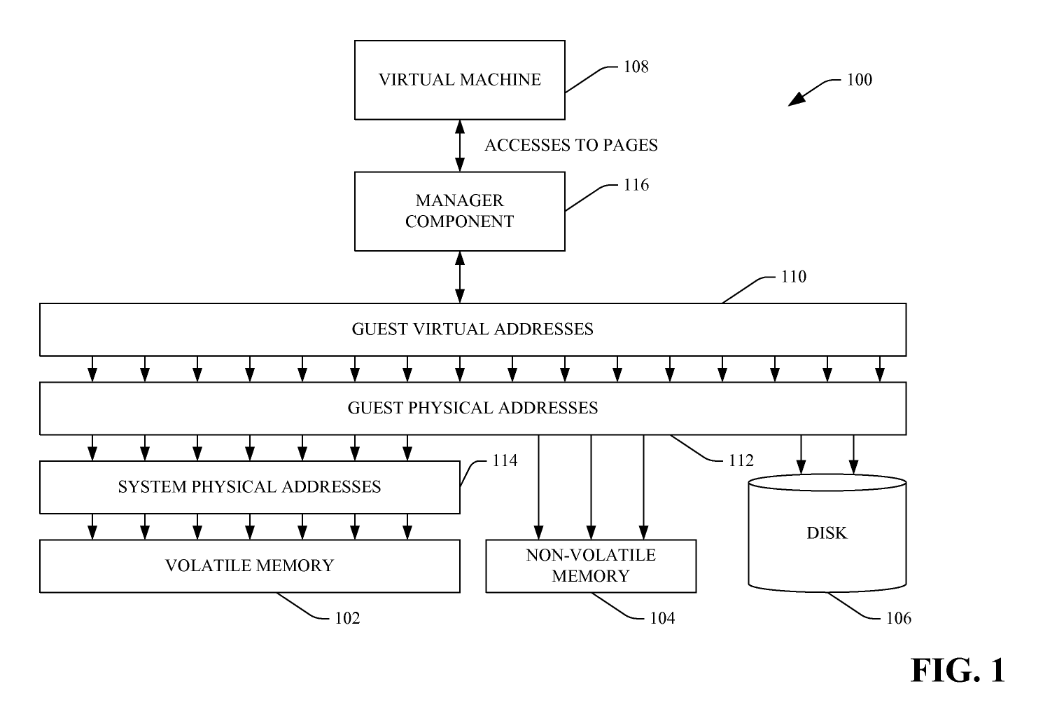

With reference to FIG. 1, an exemplary system 100 that facilitates managing memory resources in an over-committed virtualized system is illustrated. Pursuant to an example, the system 100 can be included in a server that comprises one or more processors, wherein one or more of the processor may be multi-core processors. The system 100 comprises a hierarchical memory/data storage structure. More specifically, the hierarchical memory/data storage structure includes a first tier, a second tier, and a third tier. The first tier comprises volatile memory 102, such as RAM, DRAM, SRAM, and/or other suitable types of non-volatile memory. The second tier comprises non-volatile memory 104, which can be one or more of Phase Change Memory, Flash Memory, ROM, PROM, EPROM, EEPROM, FeRAM, MRAM, PRAM, CBRAM, SONOS, Racetrack Memory, NRAM, memristor, amongst others. The third tier comprises disk 106, wherein the disk may be a hard disk drive or some other suitable storage device. The disk 106 and the non-volatile memory 104 are distinguishable from one another, as a hypervisor can have direct access to the non-volatile memory 104 while the disk 106 has a disk volume file system stack executing thereon. Accordingly, data can be read from and written to the non-volatile memory 104 more quickly than data can be paged into or paged out of the disk 106.

The system 100 further comprises a virtual machine 108 that is executing in the system 100. When executing, the virtual machine 108 may attempt to access certain portions of virtual memory, wherein the virtual memory appears to the virtual machine 108 as one or more guest virtual addresses 110. These guest virtual addresses 110 may map to guest physical addresses (GPAs) 112 as described previously. Some of the GPAs 112 can map to system physical addresses (SPAs) 114. Various mapping tables can be utilized to map the guest virtual addresses 110 to the GPAs 112 to the SPAs 114. As described above, the SPAs 114 correspond to portions of the volatile memory 102. Accordingly, data in a page corresponding to a GPA that is mapped to an SPA will reside in the volatile memory 102. Other GPAs, however, may be backed by the non-volatile memory 104 and/or the disk 106.

When the virtual machine 108 accesses a page (reads from the page, writes to the page, or executes code in the page) that is mapped to an SPA, a physical processor performs the requested operation on the page in the volatile memory 102. When the virtual machine 108 accesses a page that is mapped to the non-volatile memory 104, the page is retrieved from the non-volatile memory 104 by the hypervisor through a direct memory access and is migrated to the volatile memory 102. When the virtual machine 108 accesses a page that is backed by the disk 106, the contents of the page must be paged in from the disk 106 and mapped to an SPA, and thus placed in the volatile memory 102.

The system 100 further comprises a manager component 116 that manages allocation of physical resources to the virtual machine 108 (and other virtual machines that may be executing in the virtualized system 100). In other words, the manager component 116 dynamically determines which pages in the GPA space are desirably mapped to the SPA space, which pages are desirably backed by the non-volatile memory 104, and which pages are desirably backed by the disk 106.

When making such determinations, the manager component 116 takes into consideration physical characteristics of the volatile memory 102, the non-volatile memory 104, and the disk 106. For example, the non-volatile memory 104 can support reads at speeds comparable to the volatile memory 102 and writes that are faster than writes to the disk 106. However, generally, non-volatile memory 104 has a write endurance that is less than a read endurance—that is, the non-volatile memory 104 will “wear out” more quickly when write accesses are made to the non-volatile memory 104 compared to read accesses.

Pursuant to an example, the manager component 116 can monitor how pages are utilized by the virtual machine 108, and can selectively map the pages to the volatile memory 102, the non-volatile memory 104, and/or the disk 106 based at least in part upon the monitored utilization of the pages. For example, if the manager component 116 ascertains that the virtual machine 108 requests write accesses to a particular page frequently, the manager component 116 can map the page to an SPA, and thus place the page in the volatile memory 102. In another example, if the manager component 116 ascertains that the virtual machine requests read accesses to a page frequently, when the system 100 is over-committed, the manager component 116 can map the page to the non-volatile memory 104. In still yet another example, if the manager component 116 determines that the virtual machine 108 infrequently accesses a page, then the manager component 116 can map the page to disk when the system 100 is overcommitted. Accordingly, the manager component 116 can allocate resources across the volatile memory 102, the non-volatile memory 104, and the disk 106 to the virtual machine 108 based at least in part upon monitored utilization of pages accessed by the virtual machine 108.

While the manager component 116 is shown as being a recipient of access requests made by the virtual machine 108 to one or more pages, it is to be understood that the manager component 116 can receive such access requests indirectly. In an example, the manager component 116 can be configured to be included in a hypervisor. In another example, the manager component 116 may be a kernel mode export driver that interfaces with a portion of the virtualization software stack executing in the parent partition. In still yet another example, the manager component 116 may be distributed between the parent partition and the virtual machine 108. These and other exemplary implementations are contemplated and are intended to fall under the scope of the hereto-appended claims.

Furthermore, while FIG. 1 illustrates GVAs and GPAs, it is to be understood that in some implementations GVAs can be eliminated. For example, the virtual machine 108 may have direct access to the GPA space, which maps to the SPA space.

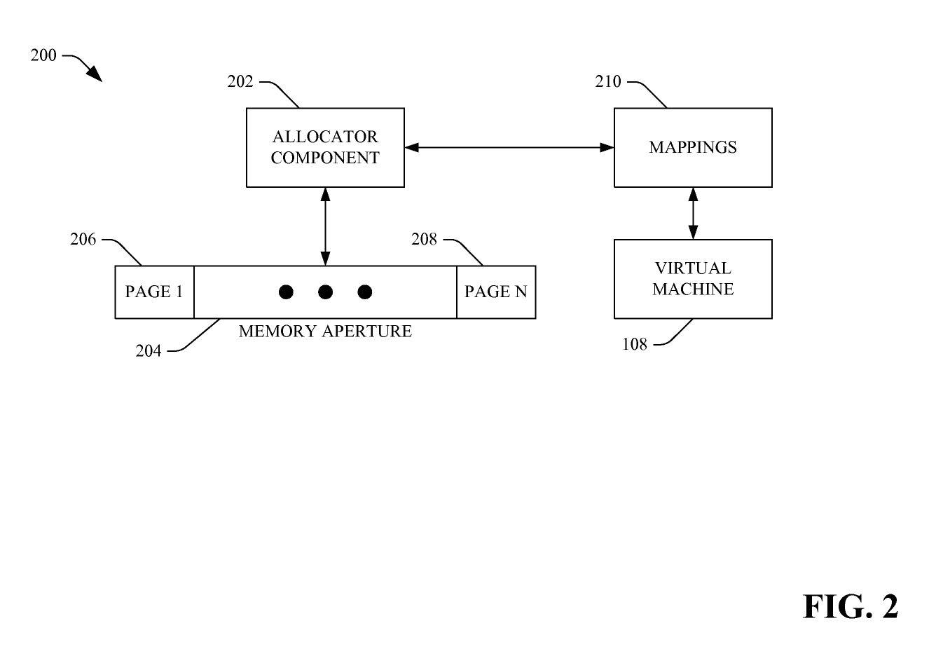

Referring now to FIG. 2, an exemplary system 200 that facilitates allocating a memory aperture to the virtual machine 108 is illustrated. The system 200 comprises an allocator component 202 that is configured to allocate a memory aperture 204 to the virtual machine 108. The memory aperture 204 comprises a plurality of pages 206-208, wherein the pages can be of some uniform size (e.g., 4 KB). The memory aperture 204 is a range of SPA pages that are often over-committed, such that a subset of the pages 206-208 are available in the SPA space and the remainder are to be backed by the non-volatile memory 104 or the disk 106. The allocator component 202 can allocate the memory aperture 204 to the virtual machine 108, and can map pages in the memory aperture 204 to appropriate hardware. For instance, the allocator component 202 can generate mappings 210 that map some of the pages 206-208 to SPAs, map some of the pages to non-volatile memory 104, and map some of the pages to the disk 106. These mappings 210 may be utilized by the virtual machine 108 to execute one or more tasks. Pursuant to an example, the mappings 210 to the different storage devices (the volatile memory 102, the non-volatile memory 104, and the disk 106) can be based at least in part upon expected usage of the pages 206-208 in the memory aperture 204 by the virtual machine 108. In an exemplary implementation, the allocator component 202 can be a portion of the VSS in the parent partition of a virtualized system.

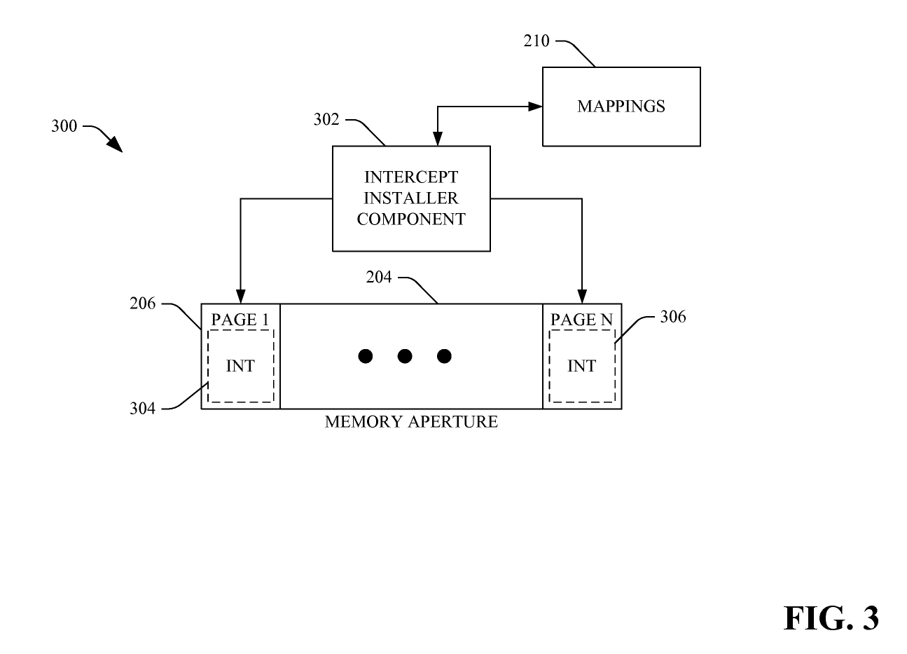

With reference now to FIG. 3, an exemplary system 300 that facilitates installing intercepts on pages in the memory aperture 204 is illustrated. Subsequent to the allocator component 202 (FIG. 2) allocating the memory aperture 204 to the virtual machine 108 and generating the mappings 210, an intercept installer component 302 can install intercepts on a subset of pages in the memory aperture 204. The intercept installer component 302 can install two different types of intercepts: 1) a GPA fault intercept and; and 2) an SPA Access Violation Intercept. The intercept installer component 302 can install a GPA fault intercept on a page in the memory aperture 204 that is backed by the non-volatile memory 104 or the disk 106. For example, the mappings 210 can indicate which pages in the memory aperture 204 are backed by which storage components. For pages in the memory aperture 204 that are marked as being backed by the non-volatile memory 104 in the mapping 210, the intercept installer component 302 can install a GPA fault intercept thereon. For instance, the page 206 in the memory aperture may have a GPA fault intercept 304 installed thereon. The intercept 304 can be a read intercept, a write intercept, or an execute intercept.

Additionally or alternatively, for pages that are backed by the volatile memory 102 (and are thus mapped to a SPA), the intercept installer component 302 can install an SPA Access Violation Intercept. In an example, the page 208 in the memory aperture 204 can have an SPA Access Violation Intercept 306 installed thereon. In an example, the intercept installer component 302 can install such an intercept 306 when a page that was initially backed by the non-volatile memory 104 is migrated to the volatile memory 102. Additional details pertaining to the GPA fault intercept and the SPA Access Violation Intercept are provided below. Further, in an exemplary implementation, the intercept installer component 302 can be included as a portion of the manager component 116 and/or as a portion of the VSS executing in the parent partition of a virtualized system.

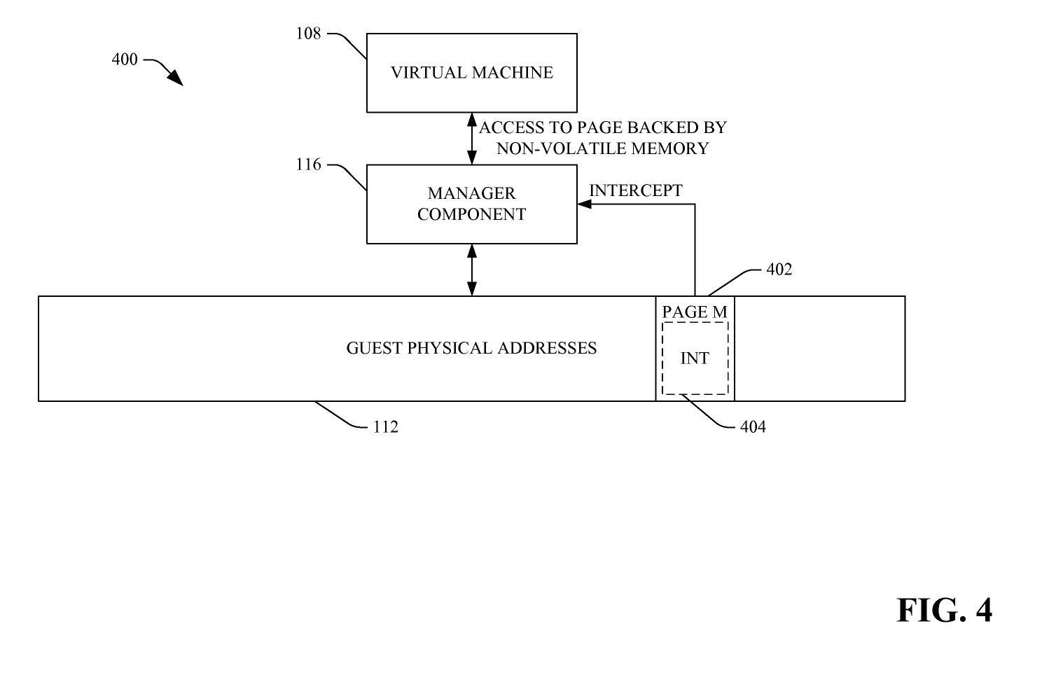

Turning now to FIG. 4, an exemplary system 400 that facilitates triggering an intercept upon accessing a page backed by non-volatile memory is illustrated. The system 400 comprises the virtual machine 108, wherein the virtual machine 108 accesses pages in the GPAs 112. In an example, at least one page 402 is backed by the non-volatile memory 104, and therefore has a GPA fault intercept 404 installed thereon. The at least one page 402 is accessed by the virtual machine 108, either explicitly or implicitly. For example, the virtual machine 108 can access the page 402 explicitly by executing code on such page 402, or can access the page 402 implicitly such as through a page-table walk that is undertaken by a hypervisor on behalf of the virtual machine 108.

As described above, the intercept 404 can be one of a read intercept, a write intercept, or an execute intercept. When the virtual machine 108 accesses the page 402, the intercept 404 is triggered. The manager component 116 can be provided details pertaining to the intercept, such as the type of access requested by the virtual machine 108, faulting instruction bytes, an instruction pointer, a virtual processor context (context of the virtual processor running in the virtual machine 108), amongst other data. This data can be utilized by the manager component 116 to determine types of accesses to the page 402 by the virtual machine 108, such that the manager component 116 can map the page to a desired storage device when a virtualized system is executing in an over-committed state.

While not shown, once the virtual machine 108 accesses the page 402 and the intercept is received by the manager component 116, the virtual processor executing in the virtual machine 108 can be suspended by the manager component 116 or other component in the virtualized system. At this point, the manager component 116 can map the contents of the page 402 to an SPA, which satisfies the GPA fault intercept. Thereafter, the virtual processor can resume execution. The content of the page 402 can be accessed by way of direct memory access when backed by the non-volatile memory 104. For example, the manager component 116 can maintain metadata pertaining to the location of the page contents for such page 402, and can use a hash index to perform direct-device access read(s) to read contents of the page 402 into an SPA to satisfy the GPA fault intercept.

Moreover, while this figure describes the page 402 as being backed by the non-volatile memory 104, in another example the page 402 can be backed by the disk 106. In such a case, the intercept 404 is triggered when the virtual machine 108 accesses such page. Contents of the page 402 are read from the disk and mapped to an SPA using conventional paging techniques, thereby satisfying the intercept 404. When the page 402 is backed by the disk 106 and read into the volatile memory 102, meta-data can be maintained at the memory aperture region level to maintain active associations.

In an exemplary implementation, when the virtual machine 108 accesses the page 402, the hypervisor can transmit data indicating that the intercept has been triggered, and the manager component 116 and the VSS can receive such indication. A portion of the VSS can determine that the page 402 is backed by non-volatile memory, which causes the VSS to delegate handling of the page 402 to the manager component 116. The manager component 116 may then maintain metadata pertaining to the location of the page contents for the GPA corresponding to the page 402 that has been assigned to the virtual machine 108.

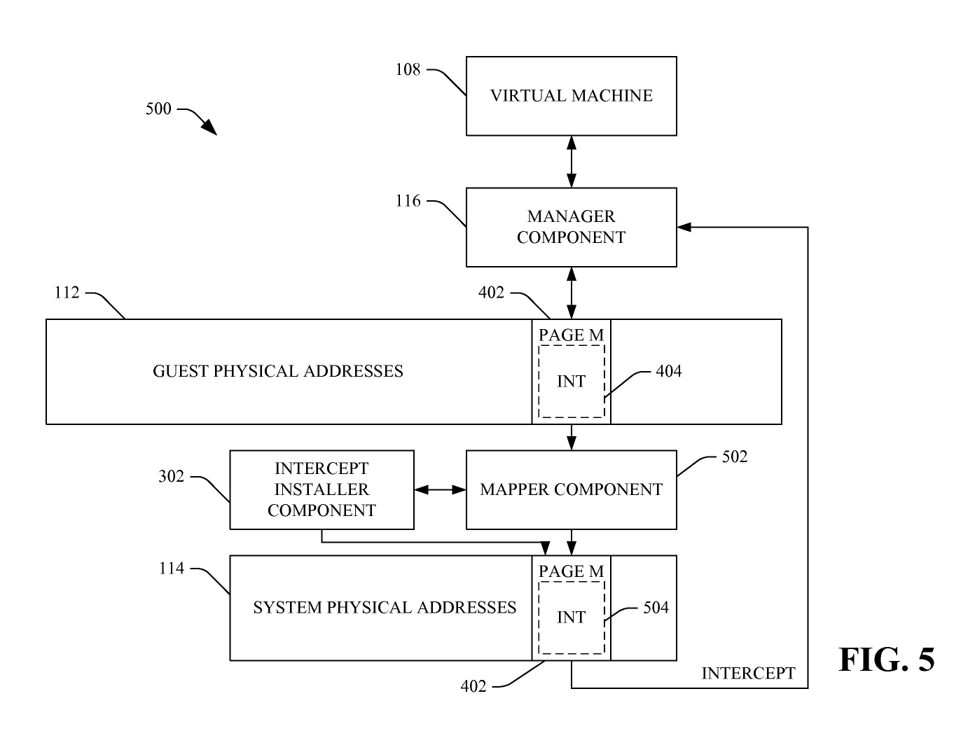

Now referring to FIG. 5, an exemplary system 500 that facilitates managing physical resources in a virtualized system is illustrated. The system 500 includes the virtual machine 108, which accesses the page 402 amongst the GPAs 112, wherein the page is backed by the non-volatile memory 104 and is not mapped to an SPA. As described previously, the GPA fault intercept 404 is installed on the page 402, and such intercept 404 is triggered upon the virtual machine 108 accessing the page 402.

A mapper component maps the page 402 to an SPA in the SPAs 114, thereby satisfying the GPA fault intercept 404. Thus, the page 402 becomes backed by the volatile memory 102. Upon the mapper component 502 mapping the page 402 to an SPA in the SPAs 114, the intercept installer component can install an SPA Access Violation Intercept 504 on such page 402.

When the virtual machine 108 accesses the page 402 in the volatile memory 102, the intercept 504 is triggered. The intercept can indicate a type of access undertaken on the page 402 by the virtual machine 108. The manager component 116 can receive data pertaining to the intercept, and can monitor how the virtual machine 108 utilizes the page 402. The manager component 116 may then determine how to handle the page 402 during a subsequent over-commit state. For example, based upon types and frequencies of accesses to the page 402 by the virtual machine 108, the manager component 116 can determine where to send the page 402 during a subsequent over-commit state (e.g., whether to retain the page 402 in the volatile memory 102, whether to place the page 402 in the non-volatile memory 104, or whether to place the page 402 in the disk 106).

For instance, if the page 402 is primarily used as a write cache/buffer, the page 402 is best suited to be retained in the volatile memory 102 if accesses to the page 402 are frequent or in the disk 106 if accesses to the page 402 are infrequent. If the page 402 is primarily uses for read operations, then the page 402 may desirably be retained in the volatile memory 102 if accesses are frequent or in the non-volatile memory 104.

In an exemplary embodiment, the manager component 116 can comprise the intercept installer component 302, and can cause the SPA Access Violation Intercept to be installed on the page 402 when the mapper component 502 maps the page 402 to an SPA in the SPAs 114. When the virtual machine 108 accesses the page 402 in the SPA, the hypervisor can transmit the intercept to the manager component 116, which can either directly manage allocation of resources or operate in conjunction with the VSS to allocate resources to the virtual machine 108 across the volatile memory 102, the non-volatile memory 104, and the disk 106.

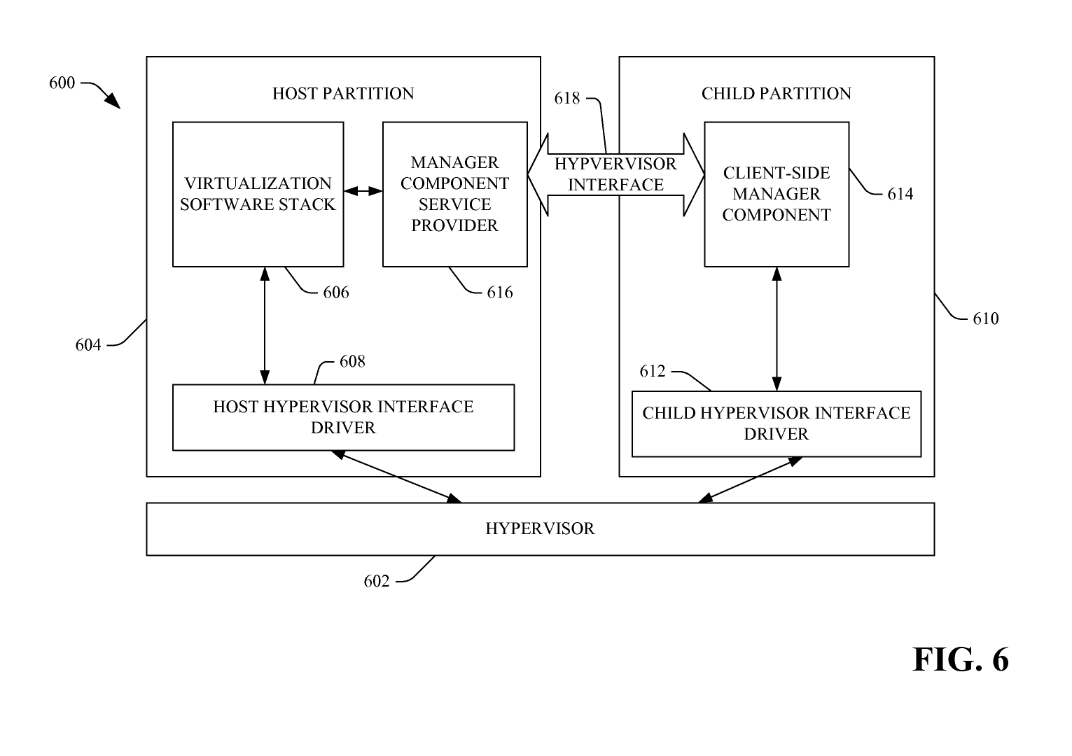

With reference now to FIG. 6, an exemplary embodiment of a virtualized system 600 that facilitates managing data storage resources is illustrated. The system 600 includes a hypervisor 602 that is configured to provide a plurality of isolated execution environments. A host partition 604 is in communication with the hypervisor 602, wherein the host partition 604 is configured to act in conjunction with the hypervisor 602 to create virtual machines (child partitions) and manage resource allocation amongst virtual machines in the virtualized system 600. The host partition 604 comprises a virtualization software stack 606, which can be a set of drivers and services that manage virtual machines and further provides APIs that are used to create, manage, and delete virtual machines in the virtualized system 600. For instance, the host partition 604 can include a host hypervisor interface driver 608, which is created/managed by the virtualization software stack 606. The host hypervisor interface driver 608 interfaces the host partition 604 with the hypervisor 602, thereby allowing the hypervisor 602 and the host partition 604 to act in conjunction to create and manage a plurality of child partitions in the virtualized system 600.

The system 600 further comprises a child partition 610 created by the virtualization software stack 606 and the hypervisor 602. A virtual machine executes in the child partition 610, wherein the child partition 610 can be considered as a repository of resources assigned to the virtual machine. The child partition 610 comprises a child hypervisor interface driver 612, which is an interface driver that allows the child partition 610 to utilized physical resources via the hypervisor 602.

The child partition 610 further comprises a client-side manager component 614, which can receive data from the hypervisor 602 pertaining to intercepts triggered by accesses to certain pages as described above. The data pertaining to the intercepts may be received from the hypervisor 602 by way of the child hypervisor interface driver 612. The host partition 604 comprises a manger component service provider 616, which is in communication with the client-side manager component 614 by way of a hypervisor interface 618. This can be a separate interface from the host hypervisor interface driver 608 and the child hypervisor interface driver 612. Alternatively, the hypervisor interface 618 shown can be the interface created via such drivers 608-612.

The manager component service provider 616 can receive data pertaining to the intercepts from the client-side manager component 614, and can manage physical resources pertaining to the child partition 610 as described above. Additionally, when an intercept is encountered, the virtualization hardware stack 606 can pass control with respect to a page to the manager component service provider 616, and the manager component service provider 616 can undertake actions described above with respect to monitoring accesses to pages, mapping pages to SPAs, etc.

It is to be understood that the implementation of the virtualized system shown in FIG. 6 is exemplary in nature, and that various other types of implementations are contemplated and are intended to fall under the scope of the hereto-appended claims. Furthermore, the systems 100, 200, 300, 400, 500, and 600 have been described herein as utilizing intercepts to monitor how pages in a virtualized system are being accessed. It is to be understood, however, that any suitable manner for determining how pages are accessed by virtual machines are intended to fall under the scope of the claims.

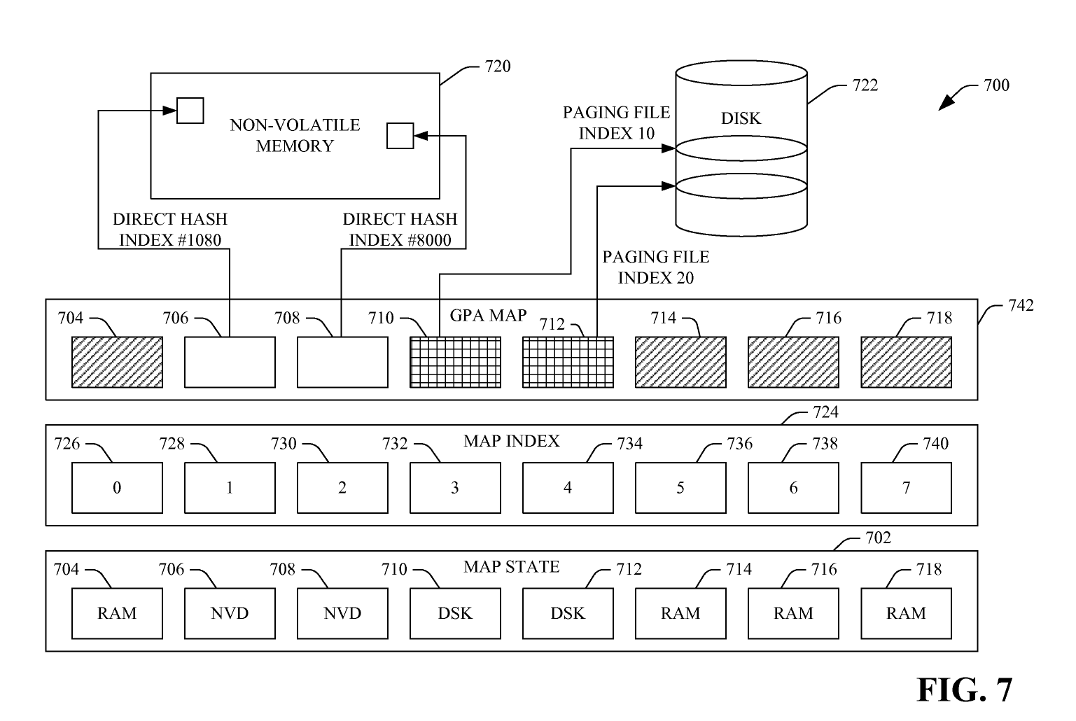

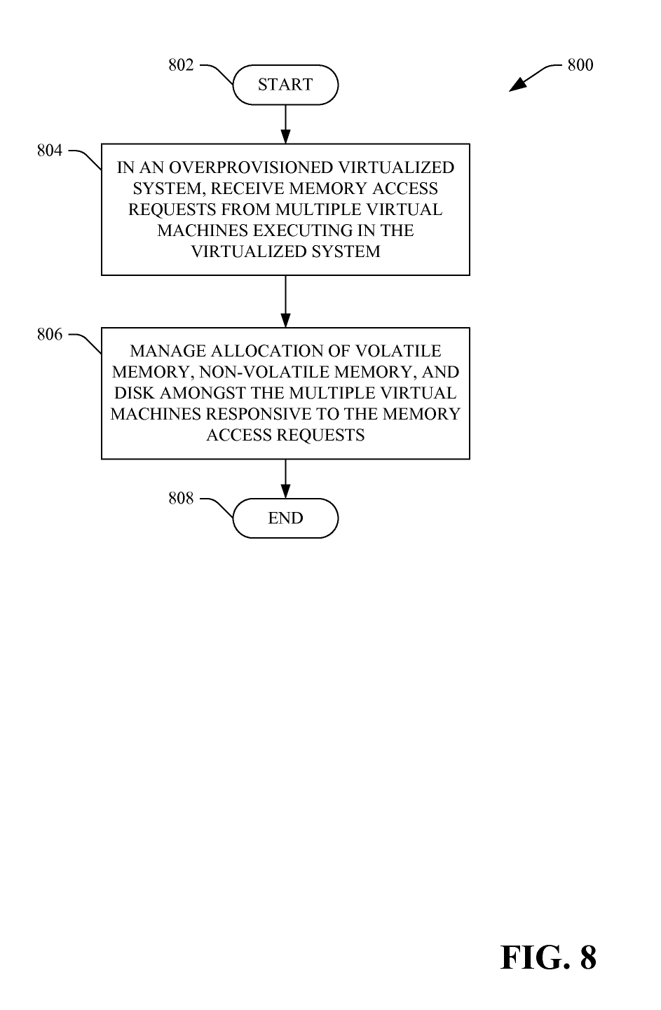

With reference now to FIGS. 7-8, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Turning now to FIG. 7, an exemplary mapping 700 of pages in a GPA space to volatile memory, non-volatile memory, and disk is illustrated. The mapping 700 includes a map state 702, which illustrates states of various memory apertures 704-718 in a virtualized, hierarchical memory system. Specifically, the apertures 704, 714, 716, and 718 are resident in RAM, the apertures 706 and 708 are resident in non-volatile memory 720, and the apertures 710 and 712 are resident in disk 722.

A map index 724 indexes the apertures 704-718 to the states described above. Specifically, the map index 724 comprises indices 726-740 that indexes the memory apertures to the states shown in the map state 702.

A GPA Map 742 is presented to illustrate the mapping of the memory apertures 704-718 to the appropriate storage devices by way of the map index 724 and the map state 702. Specifically, the map indices 0, 5, 6, and 7 show memory apertures 704, 714, 716, and 718 that are backed by committed SPA pages, the map indices 1 and 2 show memory apertures that are not mapped with SPA but are available by way of direct memory access from the non-volatile memory 720, and the map indices 3 and 4 show memory apertures that are not backed by SPA and contents of the memory are paged out to the disk 722 by way of a paging subsystem.

As will be understood by one or ordinary skill in the art, pages in the memory apertures backed by SPA can be directly accessible to a processor, and pages in memory apertures backed by the non-volatile memory 720 can be accessed by the processor using a hash index to perform direct-device access reads to read contents of the page. Pages in the memory apertures 710 and 712 backed by the disk 722 are paged into an SPA through utilization of conventional paging techniques.

Referring now to FIG. 8, a methodology 800 that facilitates managing data storage resources in a virtualized system is illustrated. The methodology 800 begins at 802, and at 804 memory access requests are received from multiple virtual machines executing in an over-committed (over-provisioned) virtualized system. In other words, there is insufficient volatile memory to service each of the requests, so other storage mediums are utilized when executing the virtual machines.

At 806, allocation of volatile memory, non-volatile memory, and disk is managed across the multiple virtual machines based at least in part upon the memory access requests. As described herein, the allocation can be based at least in part upon historic utilization of pages by the virtual machines (e.g., frequency of access of certain pages, type of access with respect to certain pages, . . . ). Furthermore, it is to be understood that the non-volatile memory can be directly accessed by a hypervisor in the virtualized system, while the hypervisor cannot directly access contents of the disk. The methodology 800 completes at 808.

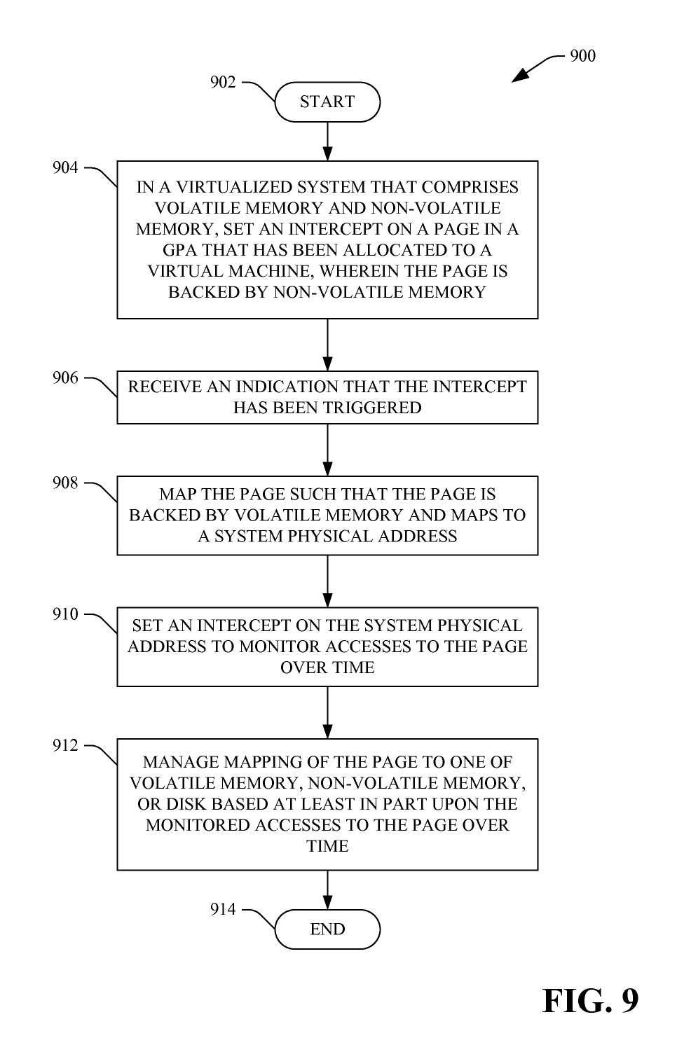

With reference now to FIG. 9, an exemplary methodology 900 for managing data storage resources (e.g., memory and disk) in a virtualized system is illustrated. The methodology 900 starts at 902, and at 904, in a virtualized system that comprises volatile memory and non-volatile memory, an intercept is set on a page that corresponds to a guest physical address that has been allocated to a virtual machine, wherein the page is backed by non-volatile memory.

At 906, an indication that the intercept has been triggered is received. In other words, the virtual machine that has been allocated the page has accessed such page. The indication can include a type of access, context pertaining to the virtual processor executing code, etc.

At 908, the page is mapped to a SPA such that the page is migrated to volatile memory. At 910, an intercept is set on the page (in the GPA or SPA) to monitor accesses to the page over time by the virtual machine. At 912, mapping of the page to one of volatile memory, non-volatile memory, or disk is managed based at least in part upon the monitored accesses to the page by the virtual machine over time. The methodology 900 completes at 914.

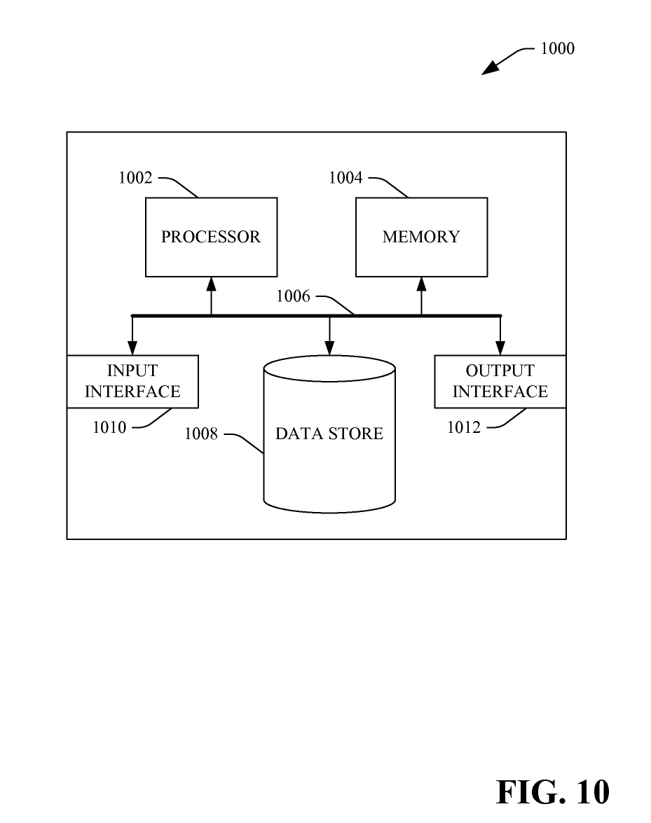

Now referring to FIG. 10, a high-level illustration of an example computing device 1000 that can be used in accordance with the systems and methodologies disclosed herein is illustrated. For instance, the computing device 1000 may be used in a system that supports virtualization in a computing apparatus. In another example, at least a portion of the computing device 1000 may be used in a system that supports managing physical data storage resources with respect to virtual machines executing in a virtualized system. The computing device 1000 includes at least one processor 1002 that executes instructions that are stored in a memory 1004. The memory 1004 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store pages, mappings between virtualized memory and system physical addresses, etc.

The computing device 1000 additionally includes a data store 1008 that is accessible by the processor 1002 by way of the system bus 1006. The data store 1008 may be or include any suitable computer-readable storage, including a hard disk, memory, etc. The data store 1008 may include executable instructions, historic memory access data, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

Additionally, while illustrated as a single system, it is to be understood that the computing device 1000 may be a distributed system. Thus, for instance, several devices may be in communication by way of a network connection and may collectively perform tasks described as being performed by the computing device 1000.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A computing apparatus, comprising:
a processor; and
memory, wherein the memory comprises volatile memory and non-volatile memory, wherein contents of the memory are accessible to the processor;
a plurality of virtual machines executing on the processor, wherein the plurality of virtual machines are configured to access both the volatile memory and the non-volatile memory; and
a manager component that manages allocation of the volatile memory and the non-volatile memory across the plurality of virtual machines during execution of the plurality of virtual machines on the processor.

2. The computing apparatus of claim 1, wherein the non-volatile memory comprises phase change memory.

3. The computing apparatus of claim 1, wherein the non-volatile memory comprises flash memory.

4. The computing apparatus of claim 1, wherein the manager component is configured to manage allocation of non-volatile memory across the plurality of virtual machines based at least in part upon historic usage of a portion of the non-volatile memory by at least one of the plurality of virtual machines.

5. The computing apparatus of claim 1, further comprising a hypervisor, wherein the hypervisor comprises the manager component.

6. The computing apparatus of claim 5, wherein the non-volatile memory comprises a memory aperture, wherein the memory aperture is a plurality of pages that are accessible to the hypervisor when allocating memory across the plurality of virtual machines.

7. The computing apparatus of claim 6, further comprising an intercept installer component that installs an intercept on a page in the memory aperture, wherein the intercept is triggered when one of the plurality of virtual machines accesses the page in the memory aperture, wherein the manager component manages allocation of the volatile memory and the non-volatile memory across the plurality of virtual machines based at least in part upon the triggered intercept.

8. The computing apparatus of claim 7, wherein the intercept indicates that the virtual machine has one of attempted to read from the memory aperture, written to the memory aperture, or executed code in the memory aperture.

9. The computing apparatus of 8, wherein responsive to trigger of the intercept, the manager component migrates the page from the non-volatile memory to the volatile memory.

10. The computing apparatus of claim 1, wherein the computing resources have been over-provisioned across the plurality of virtual machines.

11. The computing apparatus of claim 1, further comprising a hypervisor, wherein the hypervisor has direct access to contents of the non-volatile memory by way of a hash index.

12. The computing apparatus of claim 1, further comprising a disk, wherein the manager component selectively maps pages to the volatile memory, the non-volatile memory, and disk based at least in part upon historic utilization of the pages by one or more of the plurality of virtual machines.

13. A method comprising the following computer-executable acts:
receiving a request to access a page from a virtual machine in an over-committed virtualized system, wherein the page appears to the virtual machine as a portion of memory allocated to the virtual machine;
managing physical data storage resources on a computing apparatus based at least in part upon the request to access the page from the virtual machine, wherein the physical data storage resources comprise volatile memory and non-volatile memory.

14. The method of claim 13, wherein the physical data storage resources further comprise disk.

15. The method of claim 13, wherein the non-volatile memory is phase change memory.

16. The method of claim 13, wherein the page corresponds to a guest physical address, and further comprising installing an intercept on the page, wherein the virtual machine requesting access to the page causes the intercept to be triggered, and wherein the physical data storage resources are managed based at least in part upon the triggered intercept.

17. The method of claim 16, wherein the triggered intercept indicates that the access request was one of a read access request, a write access request, or an execute request.

18. The method of claim 17, wherein the page is backed by non-volatile memory prior to the intercept being triggered, and further comprising migrating the page from non-volatile memory to volatile memory subsequent to the intercept being triggered.

19. The method of claim 18, further comprising:
subsequent to the page being migrated to the volatile memory, installing an intercept on the page that is configured to indicate nature of an access to the page when the virtual machine accesses the page.

20. A computer-readable medium comprising instructions that, when executed by a processor, cause the processor to perform acts comprising:
in a virtualized system that comprises volatile memory, non-volatile memory, and disk, setting an intercept on a page in a guest physical address that is accessible to a virtual machine, wherein the page is backed by the non-volatile memory;
receiving an indication that the virtual machine has accessed the page by way of the intercept on the page;
migrating the page to volatile memory subsequent to the virtual machine accessing the page such that the page corresponds to a system physical address;
subsequent to the migrating of the page to the volatile memory, setting a second intercept on the page, wherein the second intercept is configured to trigger upon the virtual machine accessing the page;
monitoring accesses to the page in volatile memory through utilization of the second intercept; and
managing mapping of the page to one of the volatile memory, the non-volatile memory, or disk based at least in part upon the monitoring of the accesses to the page in the volatile memory.
